(19) United States
(12) Patent Application Publication
(10) Pub. No.: US 2015/0236439 A1
(43) Pub. Date: Aug. 20, 2015

(54) PLATED TERMINAL FOR CONNECTOR, AND TERMINAL PAIR

(71) Applicants: AutoNetworks Technologies, Ltd., Yokkaichi-shi, Mie (JP); Sumitomo Wiring Systems, Ltd., Yokkaichi-shi, Mie (JP); SUMITOMO ELECTRIC INDUSTRIES, LTD., Osaka-shi, Osaka (JP)

(72) Inventors: Masayuki Okubo, Yokkaichi-shi (JP); Yasushi Saitoh, Yokkaichi-shi (JP); Yoshifumi Saka, Yokkaichi-shi (JP)

(21) Appl. No.: 14/422,273

(22) PCT Filed: Aug. 19, 2013
(86) PCT No.: PCT/JP2013/072073

§ 371 Date: Feb. 18, 2015

(30) Foreign Application Priority Data
Aug. 31, 2012 (JP) 2012-191099

(51) Int. Cl. H01R 13/03; H01R 13/11

(52) U.S. Cl. CPC H01R 13/03; H01R 13/11

(57) ABSTRACT

It is aimed to provide a plated terminal for connector and a terminal pair having a tin layer on an outermost surface and achieving both a reduction of a terminal insertion force and a reduction of a contact resistance. The plated terminal for connector includes a coating layer containing tin and a hard metal harder than tin at a contact portion to be brought into contact with another electrical conductive member, and both an area where tin is exposed on an outermost surface and an area where the hard metal is exposed on the outermost surface or an area where the hard metal is coated with a tin layer thinner than in other parts are included in the contact portion. Such a material can be obtained, for example, by forming a tin layer on a surface of a base material having an uneven structure on a surface of which a hard metal layer is formed.

### BACKGROUND

1. Field of the Invention

The present invention relates to a plated terminal for connector and a terminal pair and, more particularly to a plated terminal for connector and a terminal pair requiring a low insertion force.

2. Description of the Related Art

Copper or a copper alloy having good electrical conductivity is typically used for an electrically conductive member used in an electrical connection terminal or the like. Further, in recent years, aluminum and aluminum alloys have come to be used as materials for electrical connection terminals substituting for copper and copper alloys.

Since insulating films such as oxide films are formed on surfaces of copper and copper alloys or aluminum and aluminum alloys, a contact resistance at the time of contacting another conductor increases. Accordingly, a material in which a tin layer 43 is formed after a base plating 42 made of nickel or the like is formed on a surface of a base material 41 made of copper, a copper alloy, aluminum, an aluminum alloy or the like as shown in FIG. 6 if necessary has been used as a material for a connector terminal for automotive vehicle. Tin is characterized by being very soft as compared with other metals. In a tin-plated terminal, a relatively hard tin oxide film is formed on a surface of a tin layer. However, since the tin oxide film is destroyed with a weak force and the soft tin layer is easily exposed, a good electrical contact is formed.

However, similarly due to the softness of tin, the tin-plated terminal has a problem of a high friction coefficient at the time of connecting the terminal. As shown in FIG. 6, the tin layer 43 is easily scraped off or tin easily adheres to itself when a connector contact point slides on the surface of the soft tin layer 43. This increases a friction coefficient on the surface of the tin layer 43, whereby a force necessary to insert the connector terminal (insertion force) increases.

Accordingly, an attempt has been made to form a base plating layer made of a hard tin-containing alloy on a base material side of a soft tin layer and suppress an insertion force of a tin-plated terminal. For example, Japanese Unexamined Patent Publication No. 2003-151668 discloses a terminal in which a nickel plating layer, a copper plating layer, a tin plating layer are successively laminated on a surface of a base material made of a copper alloy and a copper-tin alloy is formed between the copper plating layer and the tin plating layer by a reflow process. Further, Japanese Unexamined Patent Publication No. 2007-204854 discloses an electrical/electronic component using a plated material in which a base plating layer made of a group 4 to 10 metal, an intermediate plating layer formed of copper or a copper alloy and a surface plating layer formed of tin or a tin alloy are formed on an electrically conductive base material made of copper or a copper alloy and a layer of an Sn—Cu intermetallic compound is formed between the intermediate plating layer and the surface plating layer by a subsequent heat treatment.

If the hard layer as described above is formed on the base material side of the tin layer, the friction coefficient on the surface of the tin layer is reduced and the terminal insertion force is reduced. The thicker the hard layer becomes and the thinner the tin layer becomes, the more this effect is exhibited. On the other hand, an effect of reducing a contact resistance by the tin layer is reduced if the tin layer is thinned. As just described, it is difficult to achieve both a reduction of the terminal insertion force and a reduction of the contact resistance in the case of laminating the hard layer and the soft tin layer.

A problem sought to be solved by the present invention is to provide a plated terminal for connector and a terminal pair having a tin layer on an outermost surface and achieving both a reduction of a terminal insertion force and a reduction of a contact resistance.

### SUMMARY OF THE INVENTION

The present invention is directed to a plated terminal for connector, including a coating layer containing tin and a hard metal harder than tin at a contact portion to be brought into contact with another electrical conductive member, wherein both an area where tin is exposed on an outermost surface and an area where the hard metal is exposed on the outermost surface or an area where the hard metal is coated with a tin layer thinner than in other parts are included in the contact portion.

The the tin layer may be formed on a surface of a base material having an uneven structure, on a surface of which a hard metal layer made of the hard metal is formed, projections of the uneven structure are exposed on the outermost surface without being coated with the tin layer or coated with a tin layer thinner than at recesses of the uneven structure, and the contact portion includes at least one projection and at least one recess of the uneven structure.

Two or more projections of the uneven structure may be formed in an area including the contact portion, and a shortest one of distances between the projection formed in the contact portion and another projection is shorter than a longest one of straight lines crossing the contact portion.

The outermost surface of the contact portion may be formed of a surface having an unevenness height difference in the surface smaller than that of the uneven structure of the base material.

Furthermore, the base material may be obtained by forming the hard metal layer on a surface of a plate-like substrate having an uneven structure on a surface.

Two or more areas where the hard metal is exposed on the outermost surface or areas where the hard metal is coated with the tin layer thinner than in the other parts may be formed in an area including the contact portion, and a shortest one of distances between the areas is shorter than a longest one of straight lines crossing the contact portion.

The hard metal may be a copper-tin alloy.

The substrate may be made of copper or a copper alloy or aluminum or an aluminum alloy.

A nickel layer may be formed between the substrate and a layer made of the copper-tin alloy.

The present invention also is directed to a terminal pair, including a male connector terminal and a female connector terminal, wherein at least one of the male and female connector terminals is the above plated terminal for connector.

A contact load to be applied to a contact portion where the male and female connector terminals are in contact with each other may be 2 N or higher.

The hard metal harder than tin may be exposed or present by being coated with the tin layer thinner than in the other parts in the contact portion. These areas contribute to reducing a friction coefficient and a terminal insertion force at the contact portion. On the other hand, areas where relatively thick layers of tin are exposed on the outermost surface contribute to reducing a contact resistance on the surface due to the softness of tin and easiness to destroy a tin oxide film. By including both an area having an effect of reducing the friction coefficient and an area having an effect of reducing the contact resistance in the contact portion, it is possible to obtain a plated terminal for connector achieving both a low insertion force and a low contact resistance.

The tin layer may be formed on the surface of the base material having the uneven structure, on the surface of which the hard metal layer made of the hard metal is formed. The projections of the uneven structure may be exposed on the outermost surface without being coated with the tin layer or coated with the tin layer thinner than at the recesses of the uneven structure. The contact portion may include at least one projection and at least one recess of the uneven structure, and the surface of the hard base material may be exposed or coated only with the relatively thin tin layers in areas corresponding to the projections. This contributes to reducing the terminal insertion force. On the other hand, relatively thick tin layers may be formed on the base material formed with the hard metal layer in areas corresponding to the recesses. This contributes to reducing the contact resistance on the surface. By including at least one projection and at least one recess of the uneven structure in the contact portion, the effect of reducing the insertion force by the projection and the effect of reducing the contact resistance in the recess can be both enjoyed in the contact portion.

In this case, if the plated terminal for connector is so designed that two or more projections of the uneven structure are formed in the area including the contact portion and the shortest one of the distances between the projection formed in the contact portion and another projection is shorter than the longest one of the straight lines crossing the contact portion, at least one projection and at least one recess of the uneven structure are inevitably included in the contact portion. Thus, it is possible to reliably obtain a plated terminal for connector achieving both a low insertion force and a low contact resistance.

Further, if the outermost surface of the contact portion is formed of a surface having an unevenness height difference in the surface smaller than that of the uneven structure of the base material, the plated terminal for connector can be satisfactorily held in close contact with the other electrically conductive member at the positions of both the projection and the recess of the contact portion.

Furthermore, if the base material is obtained by forming the hard metal layer on the surface of the plate-like substrate having the uneven structure on the surface, a base material surface having both hardness and the uneven structure can be easily formed.

Besides in the case of using the base material having the uneven structure, if two or more areas where the hard metal is exposed on the outermost surface or areas where the hard metal is coated with the tin layer thinner than in the other parts are formed in the area including the contact portion and the shortest one of the distances between the areas is shorter than the longest one of the straight lines crossing the contact portion, both the area where the hard metal is exposed on the outermost surface or the area where the hard metal is coated with the tin layer thinner than in the other parts and the area where the relatively thick layer of tin is exposed on the outermost surface are inevitably included in the contact portion. Thus, it is possible to reliably obtain a plated terminal for connector achieving both a low insertion force and a low contact resistance.

Further, if the hard metal is a copper-tin alloy, this layer is very hard, which provides a great effect in reducing the insertion force. Further, since a copper-tin alloy layer can be formed simultaneously with a tin layer having a smooth surface by laminating a copper plating layer and a tin plating layer on the substrate in this order and applying a heat treatment, this contributes to high productivity.

Furthermore, if the substrate is made of copper or a copper alloy or aluminum or an aluminum alloy, the plated terminal for connector has high electrical conductivity.

If a nickel layer is formed between the substrate and a layer made of the copper-tin alloy, it is hindered that metal atoms in the substrate diffuse to the copper-tin alloy layer and the tin layer, an oxide is formed on the outermost surface of the contact portion and the contact resistance is increased when the plated terminal for connector is used under a heating environment. Further, the nickel layer also contributes to an increase in adhesion between the substrate and the copper-tin alloy layer.

According to the terminal pair according to the above invention, the hard metal harder than tin having the effect of reducing the friction coefficient is exposed on the outermost surface or present by being coated with the tin layer thinner than in the other parts in the contact portion where the male and female connector terminals are electrically in contact. The area where a relatively thick layer of tin having the effect of reducing the contact resistance on the surface is exposed on the outermost surface is simultaneously present in the contact portion. This enables a terminal pair achieving both a low insertion force and a low contact resistance to be obtained.

If a contact load to be applied to the contact portion where the male and female connector terminals are in contact with each other is 2 N or higher, an oxide film formed on the outermost surface of tin exposed in the contact portion can be broken to form electrical conduction between the two terminals. Thus, a good electrical connection characteristic of tin can be effectively utilized.

### BRIEF DESCRIPTION OF THE DRAWINGS

FIGS. 1A and 1B are diagrams showing the configuration of a plated terminal for connector according to one embodiment of the present invention, wherein FIG. 1A is a section of the entire plated terminal for connector and a perspective view of a contact portion and FIG. 1B is a plan view showing the configuration of a surface of a coating layer exposed on a contact portion surface.

FIG. 2 is a section showing an example of a connector terminal material utilizing an uneven structure of a base material.

FIGS. 3A and 3B are diagrams showing the structure of the contact portion, wherein FIG. 3A shows a case where the contact portion includes one each of a recess and a projection of the uneven structure and FIG. 3B shows a case where the contact portion does not include one each of the recess and the projection of the uneven structure.

FIG. 4 is a section showing a specific example of a material for connector terminal utilizing the uneven structure of the base material.

FIGS. 5A and 5B are sections showing other configurations of the connector terminal material, wherein FIG. 5A shows a case with column-like hard metal areas and FIG. 5B shows a case with three-dimensional island hard metal areas.

FIG. 6 is a diagram showing the structure of a contact portion of a conventional plated terminal for connector formed with a tin plating layer.

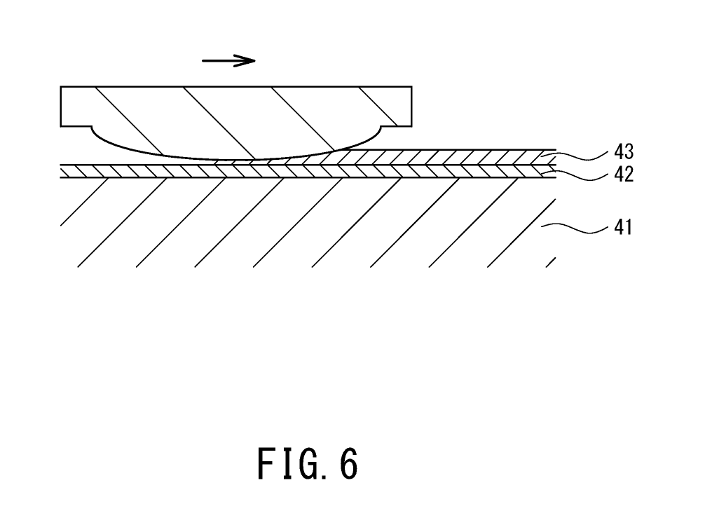

FIG. 7 is an SEM image of a surface of a plating material constituting a plated terminal for connector according to an example of the present embodiment.

FIG. 8 is a graph showing insertion forces of the plated terminal for connector according to the example and a conventional tin-plated terminal according to a comparative example.

FIG. 9 is a graph showing a contact load-contact resistance characteristic measured for the terminal material according to the example in double logarithmic scale.

### DETAILED DESCRIPTION OF THE PREFERRED EMBODIMENTS

Hereinafter, an embodiment of the present embodiment is described in detail using the drawings.

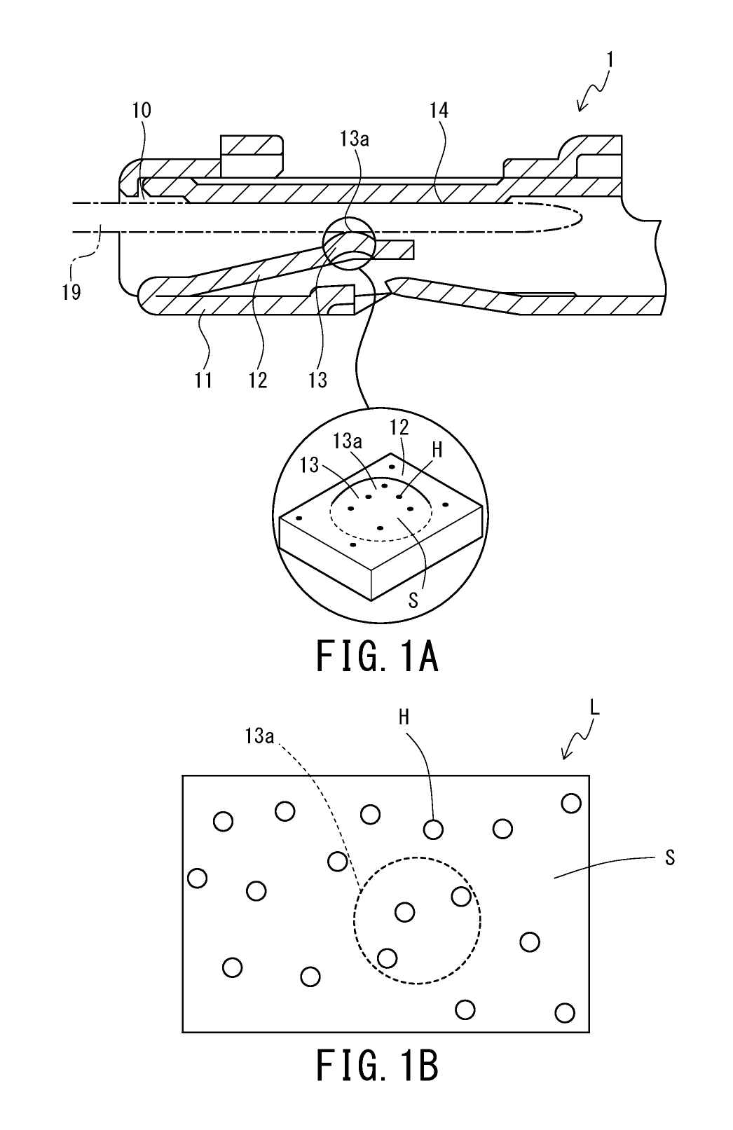

The configuration of a female plated terminal for connector 1 is shown as an example of a plated terminal for connector (hereinafter, merely referred to as a plated terminal or a terminal in some cases) according to the present invention in FIG. 1(a). The female plated terminal for connector 1 is shaped similarly to known female terminals for connector. Specifically, a pressing portion 10 of the female plated terminal for connector 1 is formed into a rectangular tube with an open front side and a male terminal 19 is inserted into the pressing portion 10. A resilient contact piece 12 folded toward an inner rear side is formed at an inner side of a bottom surface plate 11 of the female plated terminal 1. The resilient contact piece 12 applies an upward force to the male terminal 19. A surface of a ceiling plate facing the resilient contact piece 12 serves as an inner facing contact surface 14. The male terminal 19 is pressed and held between the resilient contact piece 12 and the inner facing contact surface 14 by being pressed against the inner facing contact surface 14 by the resilient contact piece 12.

A part of the resilient contact piece 12 to be held in contact with the male terminal 19 is formed with an embossed portion 13. The embossed portion 13 is held in contact with the male terminal 19 on a contact portion 13a including the top thereof. Here, the contact portion 13a means an area of a surface of the embossed portion 13 to be substantially held in contact with a mating member (male terminal 19).

In the female plated terminal for connector 1, a coating layer L including hard metal portions H and a tin portion S is formed in an area including at least the contact portion 13a. FIG. 1(b) planarly shows such a surface of the coating layer L. The hard metal portions H are scattered in the coating layer L and an area other than the hard metal portions H is made of the tin portion S. The tin portion S is an area where tin is exposed on an outermost surface. On the other hand, the hard metal portions H are areas containing a hard metal harder than tin and this hard metal is exposed on the outermost layer or coated with a tin layer thinner than in the tin portion S. In the latter case, i.e. the hard metal is coated with the thin tin layer, tin is exposed on the outermost surface both in the tin portion S and the hard metal portions H, but the tin layers coating the hard metal portions H are thinner than the tin layer coating the tin portion S. The hard metal constituting the hard metal portions H may be a pure metal or an alloy. In the case of an alloy, it may be an alloy of tin and another kind of metal or an alloy made of only a metal other than tin.

The contact portion 13a includes both the tin portion S and the hard metal portions H. For example, in FIG. 1(b), three hard metal portions H are included in the contact portion 13a and the other area is the tin portion S.

The tin portion S in which the tin layer thicker than in the hard metal portions H is formed on the outermost surface functions to provide a good electrical contact in the contact portion. Tin is very soft and an oxide film formed on a surface thereof is also easily destroyed. Thus, when a load is applied from a contact portion of a mating member with which an electrical contact is to be formed, soft metal tin is easily exposed and held in close contact with the contact portion of the mating member.

On the other hand, the hard metal constituting the hard metal portions H is harder than tin. Due to the hardness thereof, the hard metal is unlikely to be scraped off and adhere to itself on the surface and has a low friction coefficient unlike a case where a soft layer such as a tin layer is exposed on an outermost surface if being exposed on the outermost surface in the hard metal portion H. Further, even if the hard metal is coated with the tin layer and not exposed on the outermost surface in the hard metal portion H, most of a load applied to the hard metal portion H can be received by the hard metal if the tin layer is sufficiently thin. Thus, a friction coefficient of the surface is reduced. Therefore, the friction coefficient of the surface of the hard metal portion H is reduced because the hard metal is exposed or present right below the very thin tin layer coating it, with the result that an insertion force of the terminal is reduced.

As just described, a reduction of a contact resistance is realized by the tin portion S and a reduction of an insertion force is realized by the hard metal portions H. The contact portion 13a of the female plated terminal 1 includes both the tin portion S and the hard metal portions H. That is, both the tin portion S and the hard metal portions H of the contact portion 13a are held in contact with a contact portion of a mating connection member (male terminal 19). This enables the contact portion 13a to simultaneously enjoy an effect of reducing the contact resistance and that of reducing the frictional coefficient.

Note that the coating layer L including the hard metal portions H and the tin portion S is formed on a surface of a base material constituting the connector terminal, but the coating layer L and the base material therebelow need not necessarily be clearly distinguished and the base material may be entirely or partly made of the hard metal to constitute the hard metal portions L.

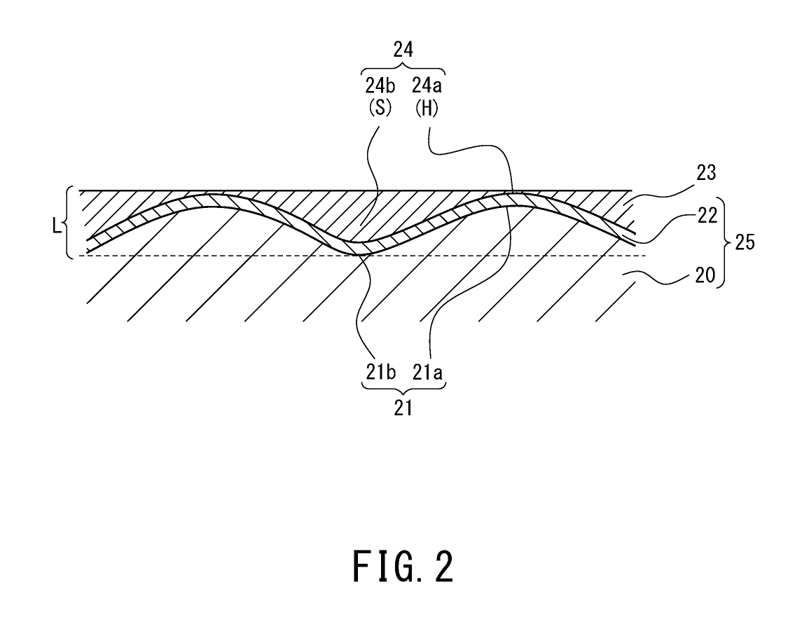

Various configurations of the coating layer L including both the tin portion S and the hard metal portions can be considered. For example, they include a configuration for forming an uneven structure on a surface of a base material as shown in FIG. 2 and utilizing such an uneven structure. Here, a tin layer 23 is formed on a surface of a base material 25 having an uneven structure formed on a surface of a hard metal layer 22. In this case, the hard metal layer 22 is formed as a part of the base material 25 and a boundary between a coating layer L and the base material therebelow is not formed as a clear layer boundary, but an area including both the hard metal layer 22 and the tin layer 22 corresponds to the coating layer L.

The base material 25 is composed of a plate-like substrate 20 and the hard metal layer 22. A substrate uneven structure 21 composed of substrate projections 21a and substrate recesses 21b is formed on a surface of the substrate 20. Here, the substrate projections 21a mean parts raised on the surface out of the substrate uneven structure 21 and the substrate recesses 2 lb means parts lowered toward an inner side of the substrate 20 out of the substrate uneven structure 21.

The hard metal layer 22 formed on the surface of the substrate 20 has a smaller thickness spatial distribution than an unevenness height difference of the substrate uneven structure 21 and an uneven structure 24 reflecting the substrate uneven structure 21 is formed on the surface of the hard metal layer 22. The uneven structure 24 is composed of projections 24a and recesses 24b. Here, the projections 24a mean parts raised on the surface out of the uneven structure 24 and the recesses 24b means parts lowered the substrate 20 out of the uneven structure 24.

The tin layer 23 is formed on the surface of the base material 25. An outermost surface of the tin layer 23 has a smooth flat surface. A smoothness level of the outermost surface of the tin layer 23 is not larger than a height difference between the projections 24a and the recesses 24b of the uneven structure 24 on the surface of the base material 25. That the surface of the tin layer 23 is smooth in this way means that the recesses 24b on the surface of the base material 25 are covered with relatively thick parts of the tin layer 23, whereas the projections 24a are covered with relatively thin parts of the tin layer 23 or exposed on the outermost surface without being coated with the tin layer 23. That is, parts where the recesses 24b are formed serve as tin portions S and particularly have an effect of reducing the contact resistance and parts where the projections 24a are formed serve as hard metal portions H and particularly have an effect of reducing the friction coefficient. Note that if the projections 24a are coated with the relatively thin parts of the tin layer 23 and not exposed, boundaries between the tin portions S and the hard metal portions H are not necessarily clear. However, the projections 24a (tops of the uneven structure 24) serve as the hard metal portions H and contributes to an effective reduction of the friction coefficient.

Here, although the base material 25 having the surface harder than the tin layer 23 and having the uneven structure 24 is formed by forming the substrate uneven structure 21 on the surface of the substrate 20 and forming the hard metal layer 22 on the substrate uneven structure 21 in the above example, similar effects can be exhibited also when the base material 25 is formed by forming the uneven structure 24 directly on the surface of the substrate 20 having no hard metal layer 22. However, in this case, the substrate 20 itself needs to be made of a hard metal harder than the tin-plated layer 23. It is not easy to form the uneven structure 24 on a surface of such a hard substrate 20, wherefore the above configuration is more preferable.

Next, an arrangement relationship of the contact portion 13a, the parts of the recesses 24b (tin portions S) and the parts of projections 24a (hard metal portions H) is described. Note that the following discussion generally holds for materials including tin portions S and hard metal portions H without being limited to the case where the tin portions S and the hard metal portions H are formed utilizing the uneven structure 24 of the base material.

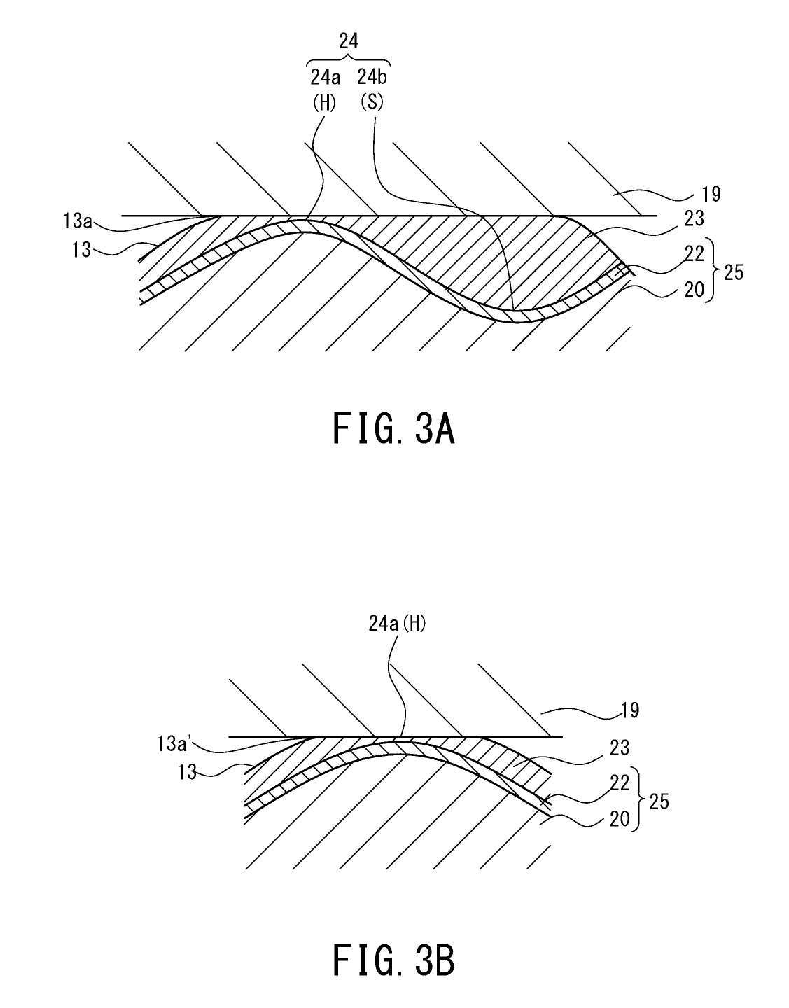

FIG. 3(a) is a diagram showing the contact portion 13a formed by using the base material 25 having the uneven structure 24 described above. In FIG. 3(a), the shape of the embossed portion 13 is expressed in an exaggerated manner to facilitate understanding.

The contact portion 13a includes one projection 24a and one recess 24b formed on the base material 25. Since the smoothness level of the outermost surface of the tin layer 23 is not larger than the height difference between the projections 24a and the recesses 24b of the uneven structure 24 on the surface of the base material 24, the contact portion 13a is in contact with the male terminal 19 in the form of a flat plate at positions of both the projection 24a and the recess 24b. This situation constantly remains unchanged even if the embossed portion 13 slides on a flat surface of the male terminal 19. By this, a friction coefficient reducing effect by the projection 24a is enjoyed and a state of a low insertion force is maintained all the time while the embossed portion 13 slides on the male terminal 19 for insertion or withdrawal. Further, even if the contact portion 13a is stopped at any position on the male terminal 19 and a current is applied, a low contact resistance effect by the recess 24b is enjoyed.

The contact portion 13a may include two or more projections 24a and/or two or more recesses 24b. In such a case, the friction coefficient reducing effect and/or the contact resistance reducing effect are further increased.

On the other hand, as shown in FIG. 3(b), there is a possible case where the contact portion does not include one or more projections 24a or one or more recesses 24a if the contact portion is smaller than in the above case and/or if an interval between the projection 24a and the recess 24b is wider than in the above case. In FIG. 3(b), a contact portion 13a′ includes only the projection 24a, but includes no recess 24b. Besides this case, possible cases include a case where the contact portion includes only the recess 24b, but includes no projection 24a and a case where the contact portion includes neither the projection 24a nor the recess 24b.

In a situation of FIG. 3(b), the friction coefficient reducing effect can be enjoyed since the contact portion 13a′ is in contact with the male terminal 19 at the projection 24a, but the contact resistance reducing effect by the recess 24b cannot be enjoyed since the recess 24b is not in contact. That is, the terminal insertion force is reduced, but the contact resistance has a relatively large value. If the contact portion includes only the recess 24b, the contact resistance reducing effect can be enjoyed, but a terminal insertion force reducing effect cannot be sufficiently obtained. If the contact portion includes neither the projection 24a nor the recess 24b, neither the insertion force reducing effect nor the contact resistance reducing effect is sufficiently obtained.

As just described, only when the contact portion includes at least one projection 24a and at least one recess 24b, the friction coefficient reducing effect and the contact resistance reducing effect thereof can be effectively utilized. One method for causing the contact portion 13a to include at least one projection 24a and at least one recess 24b may be such that an area of the contact portion 13a is designed to include at least one projection 24a and at least one recess 24b in forming the contact portion 13a using a base material with a determined arrangement of the projections 24a and the recesses 24b. An area of the contact portion of the terminal is specified by the shape and material of the contact portion. Another method may be such that an uneven structure 24 is formed on the base material 25 used to form projection(s) 24a and recess(es) 24b in the contact portion 13a with a determined area. The former method is more preferable in terms of convenience.

To cause both the projection 24a and the recess 24b to be reliably included in the contact portion 13a, a long diameter of the contact portion 13a, i.e. a length of a longest straight line out of straight lines crossing the contact portion 24a, has only to be longer than a shortest one of distances between the projection 24a formed on the contact portion 13a and the projection 24a adjacent thereto. Then, a middle point of a straight line connecting the projection formed on the contact portion 13a and at least one projection 24a adjacent thereto, i.e. the position of the recess 24b is inevitably included in the contact portion.

Note that it is an essential requirement that one or more projections 24a are included in the contact portion 13a. However, if the long diameter of the contact portion is specified based on the distance between the projections 24a as described above, at least two projections 24a need to be included on the surface of the base material 25 in an area including the contact portion 13a due to necessity to define the distance between the projections 24a. However, the second and subsequent projections 24a need not be present on the contact portion 13a.

If the uneven structure 24 is regularly arranged and can be approximated to an equal interval arrangement, the above condition is satisfied if the long diameter of the contact portion 24a is made longer than a period of the uneven structure 24. On the other hand, if the arrangement of the uneven structure 24 is irregular, it is difficult to design and manufacture each terminal in such a manner as to satisfy the condition that the long diameter of the contact portion 13a is longer than the shortest distance between the projection 24a on the contact portion 13a and the adjacent projection 24a. Instead of that, the surface of the base material may be observed with a sufficiently wide view and the area of the contact portion 13a may be so designed that the long diameter of the contact portion 13a is longer than a longest one of distances between two adjacent projections 24a. If the observation view is sufficiently wide, the above condition is satisfied regardless of which part of the plated member is used to manufacture the terminal.

In FIGS. 3, as in the case shown in FIG. 1(a), the female connector terminal is formed with the contact portion 13a as a top portion of an emboss and the uneven structure 24 is given to the contact portion 13a, whereas the male terminal 19 in the form of a flat plate is not formed with the uneven structure 24. However, the male terminal 19 may be formed with an embossed structure, a contact portion may be formed on a top portion of the embossed structure using a material composed of the base material 25 having the uneven structure 24 and the tin layer 23 and the female connector terminal may not be formed with an embossed structure and the base material 25 having the uneven structure 24 may not be used therefor.

Further, it is also possible to form not the embossed member, but the flat plate-like member by the base material 25 having the uneven structure 24 and the tin layer 23. In this case, at least one projection 24a and at least one recess 24b need to be both included in an area of a contact portion, where the both members are in contact, on a surface of the flat plate-like member. Further, this condition needs to be satisfied over the entire area where the embossed member is slid on the flat plate-like member at the time of insertion and withdrawal. Then, even if a relative positional relationship of the part of the embossed member held in contact with the flat plate-like member and the uneven structure 24 changes, both the projection 24a and the recess 24b are constantly included in the contact portion.

In a pair of male and female connection terminals, it is also possible to form contact portions of both male and female terminals from the base material 25 having the uneven structure 24 and the tin layer 23 described above. Then, larger terminal insertion force reducing effect and contact resistance reducing effect can be obtained than in the case where either one of the contact portions is formed by the base material 25 having the uneven structure 24 and the tin layer 23. In this case, it is desirable that the contact portions of the both terminals include at least one projection 24a and at least one recess 24b, but those effects can be enjoyed even if only one of the contact portions satisfies this condition.

If the hard metal layer 22 has sufficient hardness, an object of achieving both a low insertion force and a low contact resistance can be accomplished regardless of which materials are used for the hard metal layer 22 and the substrate 20. An example of a specific configuration of the base material is described below.

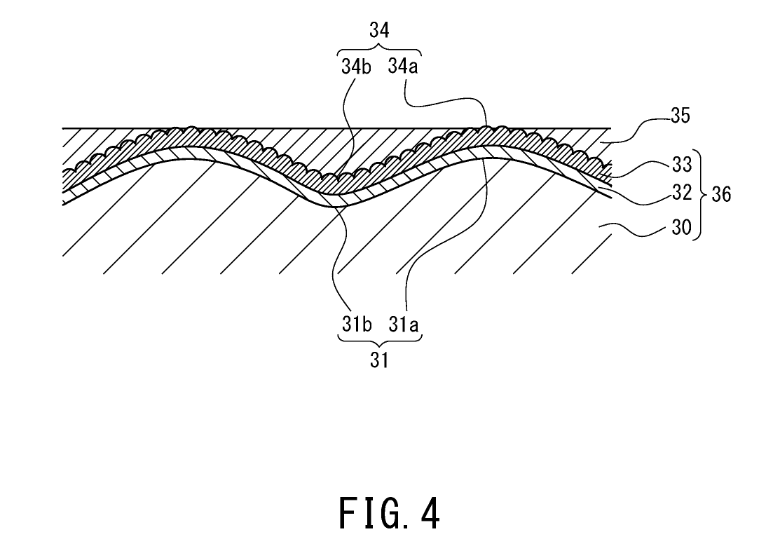

An example of the configuration of a base material is shown together with a tin plating layer in FIG. 4. A base material 36 is formed by successively laminating a nickel layer 32 and a copper-tin alloy layer 33 in this order on a surface of a substrate 30 made of copper or a copper alloy or aluminum or an aluminum alloy formed with a substrate uneven structure 31 on a surface. The substrate uneven structure 31 is reflected on an uneven structure 34 on a surface of the copper-tin alloy layer 33.

A thickness of the copper-tin alloy layer 33 is preferably in a range of 0.1 to 3.0 μm. If the copper-tin alloy layer 33 is thinner than this, the friction coefficient reducing effect is unlikely to be sufficiently exhibited. Further, if the copper-tin alloy layer 33 is thicker than this, the productivity and processability of the terminal are deteriorated.

A composition ratio of copper and tin of the copper-tin alloy layer 33 does not matter if the copper-tin alloy layer 33 is sufficiently harder than tin. Above all, the copper-tin alloy layer 33 is preferably formed to mainly contain an intermetallic compound Cu6Sn5 having hardness, oxidation resistance and corrosion resistance.

The nickel layer 32 needs not necessarily be formed, but the diffusion of metal atoms from the substrate 30 to the tin layer 35 can be hindered by forming the nickel layer 32. This prevents the metal atoms in the substrate 30 from being diffused into the tin layer 35 and oxidized on a surface to increase the contact resistance when the plated terminal is used in a high-temperature environment or when heat is generated due to power application. Further, the nickel layer 32 also functions to increase adhesion between the substrate 30 and the tin layer 35. If the substrate 30 is made of copper or a copper alloy, the former diffusion preventing effect is important. If the substrate 30 is made of aluminum or an aluminum alloy, the latter adhesion improving effect is important. A thickness of the nickel layer 32 is preferably not larger than 3.0 μm. The above effects are not sufficiently obtained if the nickel layer 32 is thinner than this, whereas the processability of the plated terminal is deteriorated if the nickel layer 32 is thicker than this.

An average value of the thickness of the tin layer 35 formed on the surface of the nickel layer 32 is desirably in a range of 0.2 to 5.0 μm and this thickness is desirably in a range of 1.2 to 20 μm at a position with a largest thickness, i.e. at the position of a recess 34b. It is difficult to sufficiently exhibit the contact resistance reducing effect if the tin layer 35 is thinner than this range, whereas it is difficult to sufficiently exhibit the friction coefficient reducing effect due to the hard copper-tin alloy layer 33 formed below the tin layer 35 if the tin layer 35 is thicker than this range.

The thickness of the tin layer 35 at a position with a smallest thickness, i.e. at the position of the projection 34a is desirably not larger than 0.2 μm. If this thickness is larger than 0.2 μm, it is difficult to sufficiently exhibit the friction coefficient reducing effect at the projection 34a due to the hard copper-tin alloy layer 33 formed below the tin layer 35. The thickness of the tin layer 35 at the position of the projection 34a may be 0. That is, the copper-tin alloy layer 33 may be exposed on the outermost surface.

An average arithmetic roughness (Ra) of the outermost surface of the tin layer 35 is desirably not smaller than 0.15 μm at least in one direction and not larger than 3.0 μm in all directions. If the average arithmetic roughness is larger than that, the smoothness of the outermost surface of the contact portion of the terminal decreases, an area to be held in contact with a mating contact portion becomes smaller and a good electrical connection cannot be achieved. Further, even if the structure of the contact portion is so designed that the projection(s) 34a and the recess(es) 34b are included in the contact portion, there is a possibility that both the projection(s) 34a and the recess(es) 34b do not contribute to contact with the mating contact portion. Then, it is not possible to simultaneously enjoy both the friction coefficient reducing effect at the position(s) of the projection(s) 34a and the contact resistance reducing effect at the position(s) of the recess(es) 34b.

An average interval between the projections 34a is desirably not larger than 0.5 mm at least in one direction. If the interval is larger than this, it becomes difficult to include at least one projection 34a and at least one recess 34b in the contact portion of the terminal for connector.

The base material 36 and the tin layer 35 may be formed by any method. For example, the substrate uneven structure 31 may be formed on the surface of the substrate 30 made of copper or a copper alloy or aluminum or an aluminum alloy by a sand blast method or the like, the nickel layer 32 may be formed on the surface of the substrate uneven structure 31 by electrolytic plating and a copper plating layer and a tin layer may be laminated in this order on the surface of the nickel layer 32. Thereafter, the copper-tin alloy layer 33 may be formed and the surface of the tin layer 35 may be smoothened by performing a reflow process thereafter.

Note that since a hard and thick oxide film is formed on the surface if the substrate 30 is made of aluminum or an aluminum alloy, it is difficult to form the nickel layer 32 directly on that surface by electrolytic plating. In this case, the nickel layer may be formed after a metal layer of zinc or the like is deposited on the surface of the substrate 30 by electrolytic plating if necessary.

It is sufficient for the plating structure having the uneven structure 34 as described above to be formed to include at least the contact portion of the plated terminal, but it is not easy to selectively form such a structure near the contact portion. It is more preferable in terms of productivity to punch out a plate member entirely formed with the base material 36 having the uneven structure 34 as described above and the tin layer 35 into a predetermined terminal shape.

Any of copper, copper alloys, aluminum and aluminum alloys can be adopted as the material for the substrate 30 and may be selected according to an intended use. For example, if a wire to be connected to the plated terminal is made of copper or a copper alloy, copper or a copper alloy may be selected as the substrate 30. If the wire is made of aluminum or an aluminum alloy, aluminum or an aluminum alloy may be selected as the substrate 30. By using the same kind of metals as the wire material and the material of the substrate 30 of the plated terminal, corrosion at joint portions thereof is prevented and electrical characteristics are maintained even if the wire and the plated terminal are used under a corrosive environment. Note that wires made of aluminum or an aluminum alloy have been used in recent years particularly in the field of automotive wiring due to a demand to make electrical wiring lighter and the like, and the importance of excellent plated terminals for connector using aluminum or an aluminum alloy as a substrate has been increased.

The connector terminal material including the hard metal portions H and the tin portions S can be easily formed by forming the tin layer 23 on the surface of the base material 25 having the hard metal layer 22 formed on the surface and having the uneven structure 24. However, it is also possible to realize a connector terminal material formed with a coating layer L including hard metal portions H and tin portions S by various other configurations.

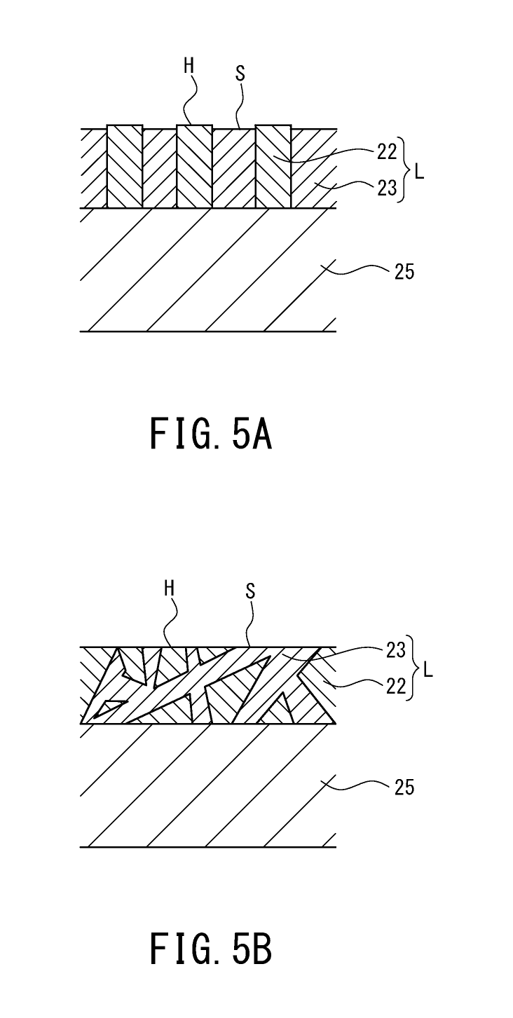

As an example, the configuration of a coating layer L utilizing column-like hard metal areas 22 is shown in FIG. 5(a). Here, the column-like hard metal areas 22 are formed on a surface of a base material 25 and tin layers 23 are formed in areas between the hard metal areas 22. The tin layer 23 may be formed with such a thickness that top parts of the hard metal areas 22 are partly exposed as shown in FIG. 5(a) or the hard metal areas 22 are coated with thin layers. Then, areas where the hard metal areas 22 are exposed or coated with thin tin layers serve as hard metal portions H and parts between the hard metal areas 22 serves as tin portions S. The column-like hard metal areas 22 can be, for example, formed by applying plating, vapor deposition or the like to the base material 25 using a mask pattern.

As another example, the configuration of a coating layer L utilizing three-dimensional domain (three-dimensional cluster) hard metal areas 22 is shown in FIG. 5(b). Here, the hard metal areas 22 and tin areas 23 are mixedly present in the coating layer L. Also on an outermost surface of the coating layer L, hard metal portions H where the hard metal areas 22 are exposed and tin portions S where the tin areas 23 are exposed are mixedly present. Such a coating layer L may be formed by a method corresponding to a property of a hard metal material such as the presence or absence of tin alloy formation. For example, a method for simultaneously plating or depositing tin and hard metal (or metal material for forming a hard metal by alloying with tin) on the surface of the base material 25 can be cited as such. Alternatively, a method for laminating a tin layer and a layer made of a hard metal (or metal material for forming a hard metal by alloying with tin) and causing tin and the hard metal to diffuse to each other by heating the laminated assembly can be cited as such.

Also in these cases, a plurality of hard metal portions H are formed on a terminal contact portion and both the hard metal portion(s) H and the tin portion(s) S can be reliably included in the contact portion if a long diameter of the contact portion is made longer than a longest one of distances between two adjacent ones of the hard metal portions H.

A terminal pair according to the embodiment of the present invention is a pair of a male connector terminal and a female connector terminal, and the coating layer L including the hard metal portions H and the tin portions S is formed on at least one of contact portions of the male and female connector terminals as described above. In this way, both the insertion force reducing effect by the hard metal portions H and the contact resistance reducing effect by the tin portions S can be enjoyed at the contact portion. These effects are more easily obtained when the coating layer L including the hard metal portions H and the tin portions S is formed on the contact portion of each of the both male and female connector terminals than when the coating layer L is formed on either one of the contact portions.

A terminal pair in which an embossed contact portion is formed on a female connector terminal and this embossed portion slides on a surface of a male connector terminal tab in the form of a flat plate for connection is often used. In this case, if the female connector terminal is formed with the coating layer L including the hard metal portions H and the tin portions S, the insertion force reducing effect can be exhibited when the coating layer L is formed at least on a surface of the embossed contact portion. On the other hand, if the male connector terminal is formed with the coating layer L, it is preferable in the sense of enjoying the insertion force reducing effect in the entire sliding area that the coating layer L is formed in the entire sliding area where the embossed contact portion of the female connector terminal slides on the flat plate-like terminal tab.

A contact load to be applied to the contact portion of such a terminal pair is preferably 2 N or higher. By applying such a load, an oxide film formed on a surface of the tin portion S exposed at the contact portion is broken. Then, soft tin in a metallic state having a low contact resistance is exposed on the outermost surface of the tin portion S and contributes to an electrical contact, wherefore high connection reliability is achieved. Note that a film resistance largely dependent on the contact load dominantly contributes to the contact resistance if the contact load is below 2 N, whereas a constriction resistance less dependent on the contact load dominantly contributes to the contact resistance if the contact load is 2 N or higher.

### EXAMPLES

The present invention is described in detail using examples.

### Example

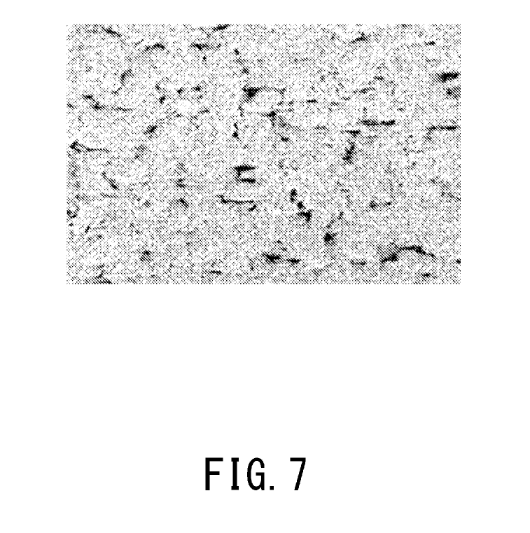

A plated member was prepared in which a nickel layer having an average thickness of 0.3 gm was formed on a copper alloy base material having an uneven structure, a copper-tin alloy layer was formed on the nickel layer, and a tin layer with a smoothened surface was formed on the copper-tin alloy layer. A thickness of the tin layer was 0.9 μm on the average. A scanning electron microscope (SEM) image of a surface of this plated member is shown in FIG. 7. A shortest interval between positions where projections of the uneven structure observed to be dark were formed was 5 μm and a longest interval was 97 μm.

After this plated member was punched out into a development shape of a terminal, bending was applied to form a female terminal for connector shaped as shown in FIG. 1(a). A long diameter of a contact portion evaluated by the SEM was 150 μm.

### Comparative Example

A plated member was prepared in which a tin layer having a thickness of 1 μm was formed on a copper alloy base material and which was used for normal tin-plated terminals, and a female terminal for connector shaped similarly to the example was formed.

### Test Method

(Evaluation of Terminal Insertion Force)

An insertion force was measured by the following method for the terminals according to the example and the comparative example. That is, using a MODEL-1605N type precision load tester produced by Aikoh Engineering Co., Ltd., the female terminal was fixed with a connection opening faced up, a male terminal attached to a load cell was moved downwardly at a head speed of 10 mm/min from above the female terminal so that an inserting direction was a downward direction, and a load cell load change was measured until insertion was completed.

(Evaluation of Contact Load-Contact Resistance Characteristic)

A contact resistance value was evaluated by measuring a contact load-contact resistance characteristic for each plated member according to the example and the comparative example. That is, the contact resistance was measured for each plated member by a four-terminal method. At this time, an open voltage was set at 20 mV, an energizing current was set at 10 mA, a load applying speed was set at 0.1 mm/min and a load of 0 to 40 N was applied in an increasing direction and a decreasing direction. One electrode was in the form of a flat plate and the other was in the form of an emboss having a radius of 1 mm.

### Test Result and Consideration

(Evaluation of Terminal Insertion Force)

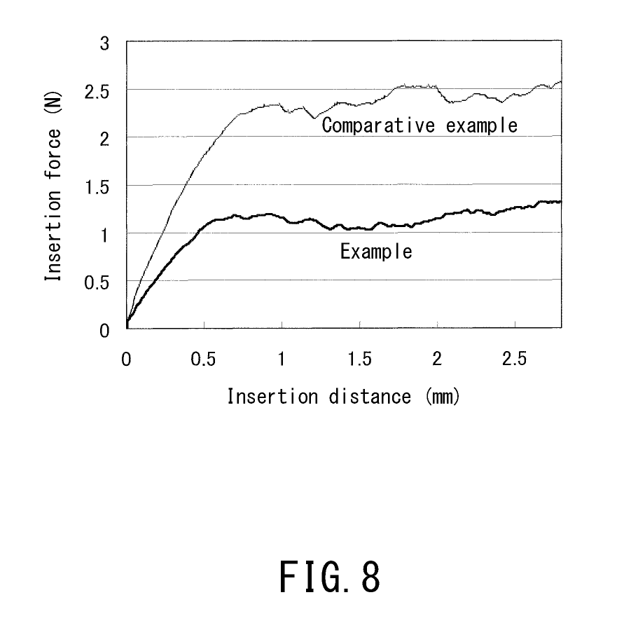

FIG. 8 shows a measurement result of the terminal insertion force. Looking at this, the insertion force is about 2.5 N for the terminal according to the comparative example, whereas the insertion force is about 1.2 N, which is less than half the former insertion force, for the terminal according to the example.

That is, a plated lamination structure in which a copper-tin alloy layer having an uneven structure was coated with a smooth tin plating layer was formed at the terminal contact portion and the projection(s) and the recess(es) of the uneven structure were included in the terminal contact portion, whereby the terminal insertion force was largely reduced as compared with the case where the normal tin-plated terminal was used.

(Evaluation of Contact Load-Contact Resistance Characteristic)

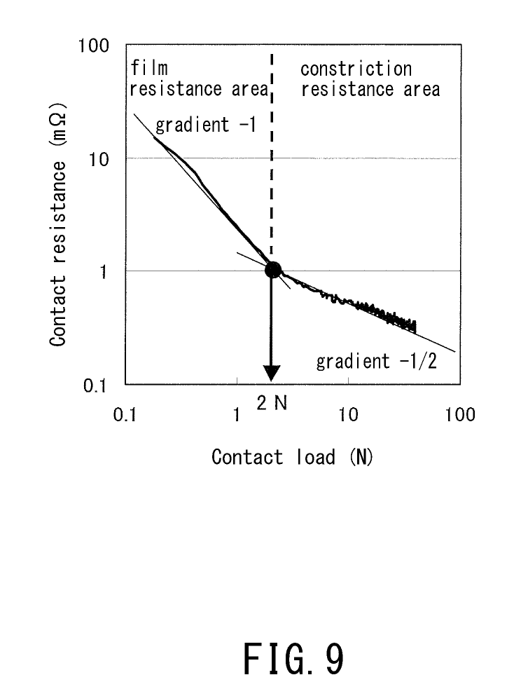

FIG. 9 is a graph showing the contact load-contact resistance characteristic measured for the plated material according to the example in double logarithmic scale.

Generally, main causes of generating a contact resistance between conductors are divided into a film resistance and a constriction resistance. The film resistance is a contact resistance generated due to the presence of an insulating film such as an oxide film formed on a surface of a conductor, and the constriction resistance results from microscopic unevenness on the surface of the conductor and is caused by the flow of a current by way of only a position of a true contact formed in a microscopic area out of a macroscopic (apparent) contact area. If a contact load is increased, the contact resistance is reduced due to physical destruction of the insulating film. That is, if a contact load necessary to destroy the insulating film is applied to the contact portion, electrical conduction can be formed in a constriction resistance area while being hardly affected by the film resistance. The dependence of the constriction resistance and the film resistance on the contact load is already formulated using models as described in Japanese Unexamined Patent Publication No. 2002-5141. According to this, a contact resistance Rk, which is the sum of a constriction resistance and a film resistance, is expressed by the following equation (1) in the case of bringing two conductors having a flat contact surface into contact.

$$\begin{matrix}[ Equation 1 ] & \\ Rk = \frac{ρ}{2} \sqrt{\frac{π H}{K S F}} + \frac{H {ρ}_{f} d}{F} & ( 1 )\end{matrix}$$

where F denotes contact load, S denotes apparent contact area, K denotes surface roughness, H denotes hardness, p denotes metal resistivity, ρf denotes film resistivity and d denotes thickness of insulation film.

In the equation (1), the first term on the right side expresses a contribution of the constriction resistance and the second term expresses a contribution of the film resistance. As is understood from the equation (1), the constriction resistance shows a dependence to the power of −½ with respect to the contact load F, whereas the film resistance shows a dependence to the power of −1 with respect to the contact load F. That is, when the dependence of the contact resistance on the contact load is shown in double logarithmic scale, an area where the film resistance is dominant is supposed to be approximated to a straight line with a gradient of −1 and an area where the constriction resistance is dominant is supposed to be approximated to a straight line with a gradient of −½. At an intersection of the two straight lines, a switch is supposed to be made from the area where the film resistance is dominant to the area where the constriction resistance is dominant.

According to FIG. 9, as is seen from thin lines representing the approximation lines, an area which can be approximated by the straight line with a gradient of −1 is observed on a low load side and an area which can be approximated by the straight line with a gradient of −½ is observed on a high load side. These areas are respectively thought to correspond to the area where the film resistance is dominant and the area where the constriction resistance is dominant. The contact load is 2 N at an intersection of the two straight lines. That is, if a contact load of at least 2 N is applied, the contribution of the film resistance having a large value and a large load dependence is substantially eliminated and an electrical contact is achieved in a constriction resistance area having a small value and a large load dependence. Thus, by applying a contact load of 2 N or higher to the contact portion of the terminal pair, a good electrical contact having a low and stable contact resistance can be obtained.

Note that, when a contact load-contact resistance characteristic was similarly measured for the plated member according to the comparative example including only the tin plating layer and shown in double logarithmic scale, an area approximated by a straight line with a gradient of −1 and an area approximated by a straight line with a gradient of −½ were seen on a low load side and a high load side and the contact load was observed to be 2 N at an intersection of the two approximation lines also in this case. That is, the contact load is the same at the intersection in the case of the example where the plated lamination structure, in which the copper-tin alloy layer having the uneven structure is coated with the smooth tin plating layer, is formed at the terminal contact portion and in the case of the comparative example where only the tin layer is formed. This means that, in the case of the example, not the copper-tin alloy layer, but the tin layer is mainly in charge of electrical conduction and a low contact resistance mainly composed of the constriction resistance of the metal tin is obtained by destroying an oxide tin film coating the surface of the tin layer exposed on the surface of the contact portion.

Although the embodiment of the present invention has been described in detail above, the present invention is not limited to the above embodiment at all and various modifications can be made without departing from the gist of the present invention.

1. A plated terminal for connector in which a tin layer is formed on a surface of a base material made of a metal harder than tin and including a hard metal layer having an uneven structure on a surface in an area including a contact portion to be brought into contact with another electrical conductive member,
wherein projections of the uneven structure are exposed on the outermost surface without being coated with the tin layer or coated with a tin layer thinner than at recesses of the uneven structure, and the contact portion includes at least one projection and at least one recess of the uneven structure.

2. The plated terminal for connector of claim 1, wherein two or more projections of the uneven structure are formed in the area including the contact portion, and a shortest one of distances between the projection formed in the contact portion and another projection is shorter than a longest one of straight lines crossing the contact portion.

3. The plated terminal for connector of claim 1, wherein the outermost surface of the contact portion is formed of a surface having an unevenness height difference in the surface specified as a height difference between the recesses and the projections smaller than that of the uneven structure of the base material.

4. The plated terminal for connector of claim 3, wherein the base material is obtained by forming the hard metal layer on a surface of a plate-like substrate having an uneven structure on a surface.

5. The plated terminal for connector of claim 4 wherein the hard metal layer is composed of a copper-tin alloy.

6. The plated terminal for connector of claim 5, wherein the base material is such that the hard metal layer composed of a copper- tin alloy is formed on a surface of a plate-like substrate having an uneven structure on a surface and a nickel layer is formed between the substrate and the hard metal layer.

7. The plated terminal for connector of claim 4, wherein the substrate is made of copper or a copper alloy.

8. The plated terminal for connector of claim 4, wherein the substrate is made of aluminum or an aluminum alloy.

9. A terminal pair, comprising a male connector terminal and a female connector terminal,
wherein at least one of the male and female connector terminals is the plated terminal for connector of claim 7.

10. The terminal pair of claim 9, wherein a contact load to be applied to a contact portion where the male and female connector terminals are in contact with each other is 2 N or higher.

11. A terminal pair, comprising a male connector terminal and a female connector terminal,
wherein at least one of the male and female connector terminals is the plated terminal for connector of claim 8.

12. The terminal pair of claim 11, wherein a contact load to be applied to a contact portion where the male and female connector terminals are in contact with each other is 2 N or higher.

13. The plated terminal for connector of claim 1, wherein the outermost surface of the contact portion is formed of a surface having an unevenness height difference in the surface specified as a height difference between the recesses and the projections smaller than that of the uneven structure of the base material.

14. The plated terminal for connector of claim 1, wherein the base material is obtained by forming the hard metal layer on a surface of a plate-like substrate having an uneven structure on a surface.

15. The plated terminal for connector of claim 1 wherein the hard metal layer is composed of a copper-tin alloy.

16. The plated terminal for connector of claim 1, wherein the base material is such that the hard metal layer composed of a copper-tin alloy is formed on a surface of a plate-like substrate having an uneven structure on a surface and a nickel layer is formed between the substrate and the hard metal layer.

17. A terminal pair, comprising a male connector terminal and a female connector terminal,
wherein at least one of the male and female connector terminals is the plated terminal for connector of claim 1.

18. The terminal pair of claim 19, wherein a contact load to be applied to a contact portion where the male and female connector terminals are in contact with each other is 2 N or higher.

19. he plated terminal for connector of claim 6, wherein the substrate is made of copper or a copper alloy.

20. The plated terminal for connector of claim 8, wherein the substrate is made of aluminum or an aluminum alloy.
